(19) United States
(12) Patent Application Publication
(10) Pub. No.: US 2017/0122668 A1
(43) Pub. Date: May 4, 2017

(54) HEAT EXCHANGER

(71) Applicant: HONDA MOTOR CO., LTD., Tokyo (JP)

(72) Inventors: Noriaki FUJII, Wako (JP); Takahiro IMAJO, Wako (JP)

(73) Assignee: HONDA MOTOR CO., LTD., Tokyo (JP)

(21) Appl. No.: 15/343,208

(22) Filed: Nov. 4, 2016

(30) Foreign Application Priority Data
Nov. 4, 2015 (JP) 2015-216680

(51) Int. Cl. F28D 9/00; F28F 9/00; B01D 5/00; F28F 9/02; B01D 61/36; F28F 3/08; F28F 9/10

(52) U.S. Cl. CPC F28D 9/0056; F28F 3/08; F28F 9/002; F28F 9/10; F28F 9/0273; B01D 61/362; B01D 5/0015; F28D 2021/0059

(57) ABSTRACT

A heat exchanger includes heat transfer plates stacked in a first direction. First branched flow paths are provided between the heat transfer plates. A first distribution portion and a first gathering portion are provided at a first position and at a second position, respectively, in a periphery of the heat transfer plates viewed in the first direction. The second position is opposite to the first position with respect to a center of the heat transfer plates viewed in the first direction. The first distribution portion and the first gathering portion connect the first branched flow paths. The first distribution portion has a first end. The first gathering portion has a fourth end. The fourth end is opposite to the first end with respect to the heat transfer plates viewed in a second direction perpendicular to the first direction.

### CROSS-REFERENCES TO RELATED APPLICATIONS

The present application claims priority under 35 U.S.C. §119 to Japanese Patent Application No. 2015-216680, filed Nov. 4, 2015, entitled “Heat Exchanger.” The contents of this application are incorporated herein by reference in their entirety.

### BACKGROUND

1. Field

The present disclosure relates to a heat exchanger.

2. Description of the Related Art

Plate heat exchangers are known as a compact heat exchanger with a large coefficient of overall heat transmission. In plate heat exchangers, the stacked heat transfer plates are rectangular, inlets and outlets for the two types of fluid performing heat exchange are provided in the four corners of the heat transfer plates such that each fluid flows in a diagonal direction along each heat transfer plates. Furthermore, a disclosure has been proposed in which, in order to increase the heat exchanging performance of such plate heat exchangers, drift suppressing ribs formed of a plurality of ribs are formed around an inflow port of the flow path that is formed between the plurality of heat transfer plates such that fluid is uniformly guided into the flow path from the inflow port (see Japanese Unexamined Patent Application Publication No. H11-243876).

### SUMMARY

According to one aspect of the present disclosure, a heat exchanger includes a plurality of heat transfer plates stacked in a first direction (a front-back direction), and either one of a first flow path through which a first fluid (raw fuel) flows and a second flow path through which a second fluid (high octane rating fuel) flows formed between a pair of the heat transfer plates adjacently disposed with respect to each other, the first flow path including a plurality of first branched flow paths formed between the pair of heat transfer plates adjacently disposed with respect to each other, the plurality of first branched flow paths arranged in parallel in the first direction, a first distribution portion provided in a periphery of the heat transfer plates when viewed in the first direction, the first distribution portion extending in the first direction and communicating the plurality of first branched flow paths to each other, a first gathering portion provided, when viewed in the first direction, in the periphery of the heat transfer plate at a position opposing the first distribution portion while interposing a center of the heat transfer plates with the first distribution portion, the first gathering portion extending in the first direction and communicating the first branched flow paths to each other, a first fluid inlet in communication with a first end side (front side) of the first distribution portion in the first direction, and a first fluid outlet in communication with a second end side (back side) of the first gathering portion in the first direction.

According to another aspect of the present disclosure, a heat exchanger includes a first flow path, a second flow path, and heat transfer plates. A first fluid flows through the first flow path. A second fluid flows through the second flow path. The heat transfer plates are stacked in a first direction. Each of the heat transfer plates is provided between the first flow path and the second flow path in the first direction. The first flow path includes first branched flow paths, a first distribution portion, a first gathering portion, a first fluid inlet, and a first fluid outlet. The first branched flow paths are provided between the heat transfer plates and arranged in parallel in the first direction. The first distribution portion is provided at a first position in a periphery of the heat transfer plates viewed in the first direction. The first distribution portion connects the first branched flow paths. The first distribution portion extends in the first direction to have a first end and a second end opposite to the first end in the first direction. The first gathering portion is provided at a second position in the periphery of the heat transfer plates viewed in the first direction. The second position is opposite to the first position with respect to a center of the heat transfer plates viewed in the first direction. The first gathering portion connects the first branched flow paths. The first gathering portion extends in the first direction to have a third end and a fourth end opposite to the third end in the first direction. The fourth end is opposite to the first end with respect to the heat transfer plates viewed in a second direction perpendicular to the first direction. The first fluid inlet communicates with the first end of the first distribution portion in the first direction. The first fluid outlet communicates with the fourth end of the first gathering portion in the first direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a cross-sectional view of a fuel separation device according to an exemplary embodiment.

FIG. 2 is an exploded perspective view of a heat exchanger illustrated in FIG. 1.

FIG. 3 is a front view of a heat transfer plate unit illustrated in FIG. 2.

FIG. 4 is a cross-sectional view of the heat exchanger corresponding to the heat exchanger taken along line IV-IV in FIG. 3.

FIG. 5 is a cross-sectional view of the heat exchanger corresponding to the heat exchanger taken along line V-V in FIG. 3.

FIG. 6 is a cross-sectional view of the heat exchanger corresponding to a heat exchanger taken along line VI-VI in FIG. 3.

FIGS. 7A and 7B are explanatory drawings of the flow in the heat exchanger illustrated in FIG. 2. FIG. 7A is the flow of the coolant and FIG. 7B is the flow of the fuel.

### DESCRIPTION OF THE EMBODIMENTS

The embodiments will now be described with reference to the accompanying drawings, wherein like reference numerals designate corresponding or identical elements throughout the various drawings.

Hereinafter, an exemplary embodiment of a heat exchanger according to the present disclosure will be described in detail with reference to the drawings. In the present exemplary embodiment, the heat exchanger is used in a fuel separation device 1 that is mounted in an automobile and that supplies fuel to an internal combustion engine.

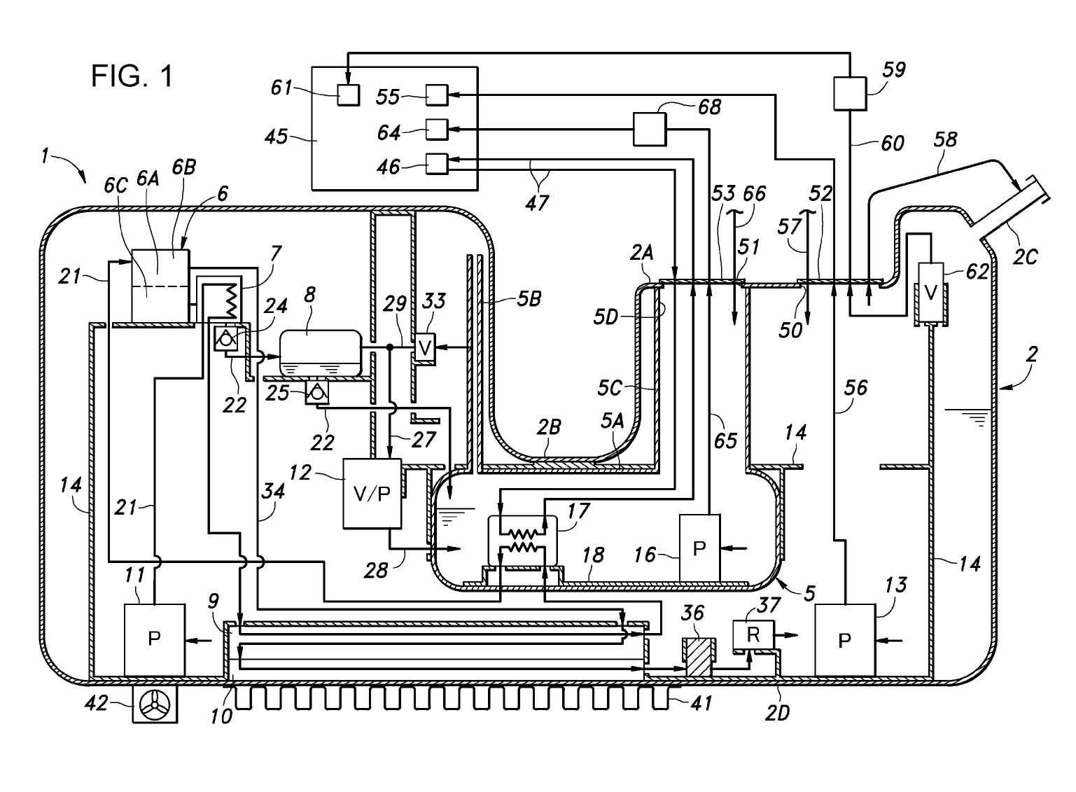

Referring first to FIG. 1, description of the fuel separation device 1 will be given. As illustrated in FIG. 1, the fuel separation device 1 includes a raw fuel tank 2 that stores raw fuel. Raw fuel is fuel containing components having different octane ratings and is mixed fuel (ethanol-containing gasoline, for example) in which alcohol, such as ethanol, is mixed in gasoline.

The shape of the fuel tank 2 may be any shape. In the present exemplary embodiment, the raw fuel tank 2 is formed in a flat shape extending in the horizontal direction and includes a recessed portion 2B recessed downwards at a middle portion in the width direction of an upper wall portion 2A. In a state in which the raw fuel tank 2 is mounted in an automobile, the recessed portion 2B is disposed at a middle portion in the width direction and components, such as a propeller shaft of the automobile, are disposed therein. The raw fuel tank 2 includes a feed pipe 2C in the upper wall portion 2A such that raw fuel can be supplied from the outside through the feed pipe 2C.

A high octane rating fuel tank 5, a separator 6, a condenser 7, a buffer tank 8, a first heat exchanger 9, a second heat exchanger 10, a fuel circulating pump 11, a vacuum pump 12, a raw fuel pump 13, and a first carrier 14 serving as a frame member that supports the above elements are provided inside the raw fuel tank 2. A high octane rating fuel pump 16, a third heat exchanger 17, and a second carrier 18 serving as a frame member that supports the above elements are provided inside the high octane rating fuel tank 5.

The fuel circulating pump 11 is provided at the bottom portion of the raw fuel tank 2. The fuel circulating pump 11 compresses the raw fuel stored inside the raw fuel tank 2 and pumps the raw fuel towards the separator 6. The condenser 7, the first heat exchanger 9, and the third heat exchanger 17 are disposed, in this order from the fuel circulating pump 11, in the route of the conduit 21 connecting the fuel circulating pump 11 and the separator 6. The raw fuel pumped from the fuel circulating pump 11 exchanges heat in the condenser 7, the first heat exchanger 9, and the third heat exchanger 17 and is supplied to the separator 6 in a state in which the temperature thereof is increased with respect to the raw fuel stored at the bottom portion inside the raw fuel tank 2. Details of the condenser 7, the first heat exchanger 9, and the third heat exchanger 17 will be described later.

The separator 6 is a device that separates the raw fuel by pervaporation (PV) into high octane rating fuel that includes more high octane rating components than the raw fuel, and low octane rating fuel that includes more low octane rating components than the raw fuel. The separator 6 includes a separation membrane 6A that selectively permeates the high octane rating component in the raw fuel, and a first chamber 6B and a second chamber 6C that are divided by the separation membrane 6A. The separation membrane 6A is, for example, a polymer membrane with no pores or an inorganic membrane including micro pores at a molecular level and is selected, as appropriate, according to the component that is separated from the raw fuel. For example, when the raw material is ethanol-containing gasoline, a membrane that selectively passes ethanol and aromatic may be selected as the separation membrane 6A.

The raw fuel that has been made to pass through the condenser 7, the first heat exchanger 9, and the third heat exchanger 17 with the fuel circulating pump 11 and that has become high in temperature and pressure is supplied to the first chamber 6B of the separator 6. The pressure in the second chamber 6C is reduced by the vacuum pump 12 described later. With the above, the high octane rating components inside the raw fuel supplied to the first chamber 6B is turned into gas, permeates through the separation membrane 6A, and is collected in the second chamber 6C. By so doing, the fuel of the second chamber 6C turns into high octane rating fuel that includes more high octane rating components than the raw fuel. Meanwhile, the high octane rating components are separated from the raw fuel supplied to the first chamber 6B as the raw fuel flows towards the outlet of the first chamber 6B such that the raw fuel turns into low octane rating fuel that includes more low octane rating components than the raw fuel. When the raw fuel is ethanol-containing gasoline, the high octane rating fuel collected in the second chamber 60 mainly contains ethanol, and the low octane rating fuel passing through the first chamber 6B contains gasoline with reduced ethanol content (concentration).

Desirably, the condenser 7 is disposed adjacent to the second chamber 6C of the separator 6. In the present exemplary embodiment, the condenser 7 is disposed adjacent to the right side of the second chamber 6C of the separator 6 and is connected to the separator 6 with a conduit 22. In the condenser 7, the gaseous high octane rating fuel supplied from the second chamber 6C and the raw fuel supplied from the fuel circulating pump 11 exchange heat without being mixed with each other. By exchanging heat, the gaseous high octane rating fuel is cooled and condensed and the raw fuel is heated.

The condenser 7 is connected to the high octane rating fuel tank 5 with the conduit 22. The buffer tank 8 is provided in the route of the conduit 22. The condenser 7 is disposed above the buffer tank 8 and the high octane rating fuel tank 5. The buffer tank 8 is disposed above the high octane rating fuel tank 5. In more detail, the positional relationship between the condenser 7, the buffer tank 8, and the high octane rating fuel tank 5 is set such that the liquid surface inside the condenser 7 is positioned above the liquid surface of the buffer tank 8 and the liquid surface of the high octane rating fuel tank 5, and the liquid surface of the buffer tank 8 is positioned above the liquid surface of the high octane rating fuel tank 5. Furthermore, desirably, the separator 6 is disposed above the buffer tank 8 and the high octane rating fuel tank 5. Owing to the positional relationship between the condenser 7, the buffer tank 8, and the high octane rating fuel tank 5, the high octane rating fuel that has turned into liquid in the condenser 7 flows into the buffer tank 8 by gravitational force and, further, flows into the high octane rating fuel tank 5 from the buffer tank 8.

A first one-way valve 24 that allows the fluid to only flow from the condenser 7 to the buffer tank 8 is provided in a portion of the conduit 22 connecting the condenser 7 and the buffer tank 8. Furthermore, a second one-way valve 25 that allows the fluid to only flow from the buffer tank 8 to the high octane rating fuel tank 5 is provided in a portion of the conduit 22 connecting the buffer tank 8 and the high octane rating fuel tank 5.

An intake port of the vacuum pump 12 is connected to a gaseous phase portion in the upper portion of the buffer tank 8 through a conduit 27. The discharge port of the vacuum pump 12 is connected to a lower portion of the high octane rating fuel tank 5 with a conduit 28. When the vacuum pump 12 is driven, the gas in the upper portion of the buffer tank 8 is conveyed to the high octane rating fuel tank 5 through the conduits 27 and 28, and the pressure in the buffer tank 8 is reduced. The reduction in the pressure in the buffer tank 8 facilitates the flow of the fluid from the condenser 7 towards the buffer tank 8, opens the first one-way valve 24 such that the pressures in the condenser 7 and the second chamber 6C of the separator 6 are reduced. In the above, the reduction in the pressure in the buffer tank 8 closes the second one-way valve 25 such that the pressure in the high octane rating fuel tank 5 is not reduced.

The conduit 27 that communicates the vacuum pump 12 and the buffer tank 8 to each other includes a branch pipe 29 branched off therefrom. An end portion of the branch pipe 29 is in communication with the gaseous phase portion of the raw fuel tank 2. In the present exemplary embodiment, a communication pipe 5B that communicates the gaseous phase portion in the upper portion inside the high octane rating fuel tank 5 and the gaseous phase portion in the upper portion of the raw fuel tank 2 to each other is provided at an upper wall portion 5A of the high octane rating fuel tank 5. The branch pipe 29 is connected to the communication pipe 5B and is in communication with the gaseous phase portion in the raw fuel tank 2 through the communication pipe 5B. The communication pipe 5B includes a first end disposed adjacent to an inner surface of the upper wall portion 2A of the raw fuel tank 2, and a second end disposed adjacent to an inner surface of the upper wall portion 5A of the high octane rating fuel tank 5.

An on-off valve 33 that is a solenoid valve is provided in the route of the branch pipe 29. The on-off valve 33 is closed when the pressure in the buffer tank 8 is reduced. When the on-off valve 33 is opened, the gas inside the raw fuel tank 2 flows into the buffer tank 8 through the communication pipe 5B, the branch pipe 29, and the conduit 27 such that the pressure inside the buffer tank 8 becomes equal to the pressure inside the raw fuel tank 2. When conveying the liquid high octane rating fuel inside the buffer tank 8 to the high octane rating fuel tank 5, the vacuum pump 12 is stopped and the on-off valve 33 is opened such that the reduction in the pressure inside the buffer tank 8 is stopped, the high octane rating fuel flows from the buffer tank 8 towards the high octane rating fuel tank 5 by gravitational force, and the second one-way valve 25 is opened.

The outset of the first chamber 6B of the separator 6 is in communication with a lower portion of a space inside the raw fuel tank 2 through a conduit 34. The first heat exchanger 9, the second heat exchanger 10, a strainer 36, and a pressure control valve 37 are provided in this order from the separator 6 side in the route of the conduit 34.

The first heat exchanger 9 is a device that exchanges heat between relatively low-temperature raw fuel that is supplied from the fuel circulating pump 11 to the separator 6, and relatively high-temperature low octane rating fuel that has passed through the separator 6 without mixing the raw fuel and the low octane rating fuel with each other. The first heat exchanger 9 may be a known countercurrent heat exchanger. By exchanging heat in the first heat exchanger 9, the raw fuel supplied from the fuel circulating pump 11 to the separator 6 is heated and the low octane rating fuel that has passed through the separator 6 is cooled.

The second heat exchanger 10 includes an internal space through which a relatively high-temperature low octane rating fuel that has passed through the separator 6 passes, and an external surface in contact with an inner surface of the wall portion of the raw fuel tank 2. The second heat exchanger 10 performs heat exchange between the low octane rating fuel and the wall portion of the raw fuel tank 2. In the present exemplary embodiment, the second heat exchanger 10 is formed in a flat sheet shape and is disposed so as to be in contact with an inner surface of a bottom wall portion 2D of the raw fuel tank 2. In order to obtain a large contact area with the bottom wall portion 2D, the second heat exchanger 10 extends over a wide range on the inner surface of the bottom wall portion 2D.

A plurality of fins 41 are provided on the external surface of the bottom wall portion 2D of the raw fuel tank 2. The fins 41 extend the external surface of the bottom wall portion 2D and facilitates the release of heat at the bottom wall portion 2D cooled with air. The fins 41 may be corrugated fins that are formed in a corrugated shape (a waveform), for example. Cooling of the bottom wall portion 2D of the raw fuel tank 2 is facilitated by the wind created by the travelling automobile in which the fuel separation device 1 is mounted.

A fan 42 is provided on the external surface of the bottom wall portion 2D of the raw fuel tank 2. The fan 42 supplies air towards the external surface of the bottom wall portion 2D and forcibly cools the bottom wall portion 2D. In other exemplary embodiments, the fan 42 may be, instead of the raw fuel tank 2, supported by a vehicle body frame or by another device constituting the automobile.

In the present exemplary embodiment, the first heat exchanger 9 is formed in a flat sheet shape and is disposed so as to be placed on an upper surface of the second heat exchanger 10. The first heat exchanger 9 and the second heat exchanger 10 are joined to each other so as to be configured as a single unit.

The low octane rating fuel that has passed through the second heat exchanger 10 passes through the strainer 36 so that foreign matter therein is removed, passes through the pressure control valve 37, is discharged to the bottom portion inside the raw fuel tank 2, and is mixed with the raw fuel. By having the low octane rating fuel be mixed with the raw fuel, the octane rating of the fuel inside the raw fuel tank 2 decreases. As the separating cycle proceeds (as the total amount of raw fuel passing through the separator 6 increases), the octane rating of the fuel inside the raw fuel tank 2 decreases and becomes close to the composition of the low octane rating fuel. The pressure control valve 37 controls the pressures of the raw fuel and the low octane rating fuel in the route from the fuel circulating pump 11 to the pressure control valve 37 to maintain the pressure of the raw fuel in the first chamber 6B of the separator 6 at a predetermined pressure. Specifically, when the pressure of the raw fuel (the low octane rating fuel) increased by the fuel circulating pump 11 becomes equivalent to or higher than a predetermined pressure, the pressure control valve 37 releases the raw fuel (the low octane rating fuel) into the raw fuel tank 2 and maintains the pressure at a predetermined value.

The third heat exchanger 17 is a device exchanging heat between raw fuel pumped from the fuel circulating pump 11 to the separator 6 and a high-temperature heat medium supplied from outside the raw fuel tank 2 without mixing the raw fuel and the heat medium with each other, and is used as a heater to heat the raw fuel. The third heat exchanger 17 may be a known countercurrent heat exchanger. The high-temperature heat medium supplied to the third heat exchanger 17 may be, for example, cooling water in which the temperature is increased by passing through an internal combustion engine 45, lubricating oil in which the temperature is increased by passing through the internal combustion engine 45 and the transmission, automatic fluid, liquid in which the temperature is increased by exchanging heat with the exhaust gas of the internal combustion engine 45, and exhaust gas. The high-temperature heat medium according to the present exemplary embodiment is cooling water of the internal combustion engine 45. A medium conveying pipe 47 that is in communication with a cooling water passage 46 of the internal combustion engine 45 is connected to the third heat exchanger 17.

The raw fuel tank 2 includes a first opening 50 and a second opening 51 that penetrates in a thickness direction of the upper wall portion 2A. The first opening 50 is closed in an openable and airtight manner with a first lid 52, and the second opening 51 is closed in an openable and airtight manner with a second lid 53.

The high octane rating fuel tank 5 is formed in a flat shape that extends in the horizontal direction, is disposed below the recessed portion 2B and above the first heat exchanger 9 and the second heat exchanger 10. A passage wall portion 5C that forms a passage that is in communication with the first opening 50 and that extends upwards in a tabular manner is provided in the upper wall portion 5A of the high octane rating fuel tank 5. An upper end opening 5D of the passage wall portion 50 is disposed so as to be aligned with the second opening 51. With the above, when the second lid 53 is opened, the outside of the raw fuel tank 2 and the inside of the high octane rating fuel tank 5 are made to be in communication with each other. An edge portion of the upper end opening 5D of the passage wall portion 5C and an edge portion of the first opening 50 do not necessarily have to be sealed in an airtight manner and they may be a gap in between.

A first fuel line 56 that connects the raw fuel pump 13 and a first injector 55 of the internal combustion engine 45 to each other, a first cable bundle 57 including a signal line and a power line of the raw fuel pump 13, a breather pipe 58 that connects the gaseous phase portion in the upper portion of the raw fuel tank 2 and an upstream end portion of the feed pipe 2C to each other, and a vapor pipe 60 that connects the gaseous phase portion in the upper portion of the raw fuel tank 2 and a canister 59 to each other penetrate the first lid 52. Portions where the first fuel line 56, the first cable bundle 57, the breather pipe 58, and the vapor pipe 60 penetrate the first lid 52 are sealed in an airtight manner.

When supplying fuel to the feed pipe 2C, the breather pipe 58 releases the gas inside the raw fuel tank 2 to the feed pipe 2C such that flow of the raw fuel into the raw fuel tank 2 is facilitated. The vapor pipe 60 releases fuel vapor inside the raw fuel tank 2 to the canister 59 to maintain the pressure inside the raw fuel tank 2 at atmospheric pressure. The fuel vapor sent to the canister 59 is occluded in an activated carbon inside the canister 59. While the internal combustion engine 45 is in operation, the fuel occluded in the canister 59 receiving negative pressure through the intake passage 61 is suctioned into and burnt in the combustion chamber. A float valve 62 is provided at an end portion of the vapor pipe 60 inside the raw fuel tank 2. The float valve 62 is opened and closed according to the liquid level of the raw fuel inside the raw fuel tank 2 to prevent the liquid fuel from flowing into the vapor pipe 60.

A second fuel line 65 that connects the high octane rating fuel pump 16 and a second injector 64 of the internal combustion engine 45 to each other, a second cable bundle 66 including a signal line and a power line of the high octane rating fuel pump 16, and the medium conveying pipe 47 for circulating the high-temperature heat medium through the third heat exchanger 17 penetrate through the second lid 53. Portions where the second fuel line 65, the second cable bundle 66, the medium conveying pipe 47 penetrate the second lid 53 are sealed in an airtight manner. The medium conveying pipe 47 is connected to the cooling water passage 46 including a water jacket of the internal combustion engine 45, and water having a relatively high temperature flows therethrough.

The second injector 64 may be, for example, a port injection injector that injects fuel to the intake port, and the first injector 55 may be, for example, a direct injection injector that injects fuel to the combustion chamber. A strainer 68 that collects foreign matter in the fuel is disposed in a portion of the second fuel supply line on the second injector 64 side with respect to the second lid 53.

The second cable bundle 66 may include a signal line to the on-off valve 33, a signal line and a power line of the fuel circulating pump 11, a signal line and a power line of the vacuum pump 12, and a signal line and a power line of the raw fuel pump 13. In such a case, desirably, the second cable bundle 66 passes through the communication pipe 5B from the inside of the high octane rating fuel tank 5 and extend into the raw fuel tank 2.

In the fuel separation device 1 configured in the above manner, since the separator 6, the high octane rating fuel tank 5, the first heat exchanger 9, the second heat exchanger 10, the third heat exchanger 17, the buffer tank 8, the vacuum pump 12 are disposed inside the raw fuel tank 2, there is no need to obtain a space separate from the raw fuel tank 2 inside the vehicle body of the automobile for disposing the above devices. Accordingly, the fuel separation device 1 can be disposed in the space where the fuel tank is conventionally disposed.

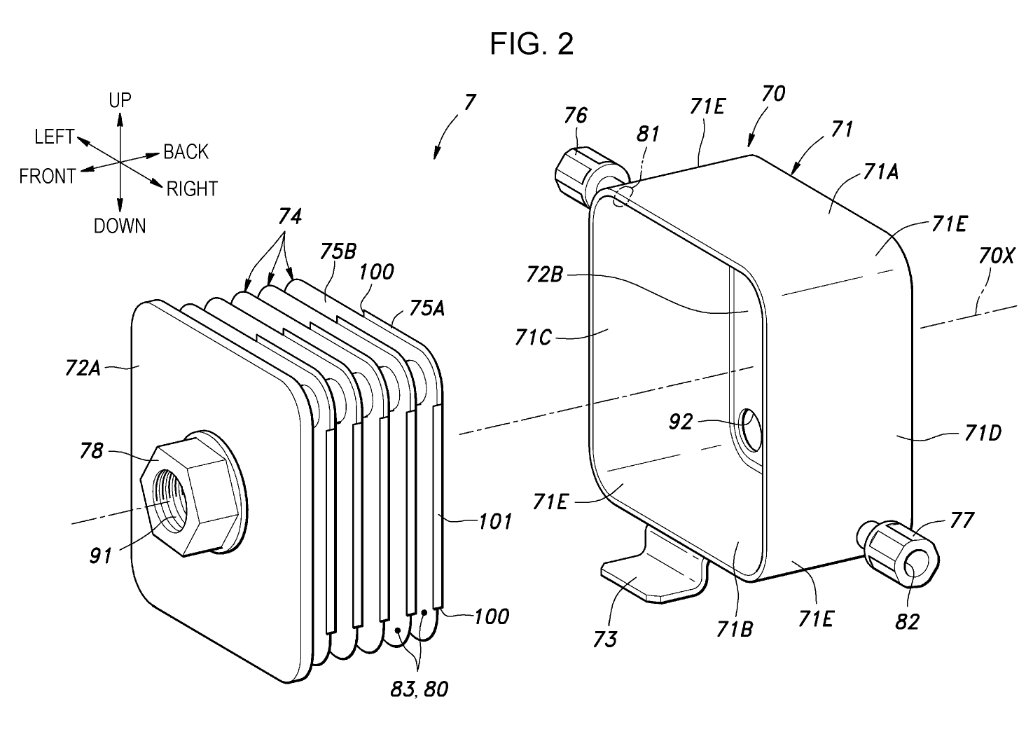

Description of the condenser 7 will be given in detail next. FIG. 2 is an exploded perspective view of the condenser 7 illustrated in the orientation in which the condenser 7 is disposed inside the raw fuel tank 2. Hereinafter, the description will be given using the directions indicated by the arrows in FIG. 2. As illustrated in the drawing, the condenser 7 includes a cylindrical housing 70 in which the axis 70X thereof extends towards the front and back. The housing 70 includes a housing body 71 in which a front end and a back end (the two ends in the axis 70X direction) thereof is open, and lid member 72A and 72B on the front side and back side that close the front and back open ends of the housing body 71. The housing body 71 includes an upper wall 71A, a lower wall 71B, a left wall 71C, and a right wall 71D, and is a square tube having a substantially square shape in which walls 71A to 71D are connected to each other through curved corner portions 71E. The housing body 71 is formed by cutting a long steel tube member into a predetermined length, for example. Each lid member 72 is configured of a square steel plate in which the periphery thereof is bent so as to form flanges. A support member 73 is joined to the underside of the housing body 71.

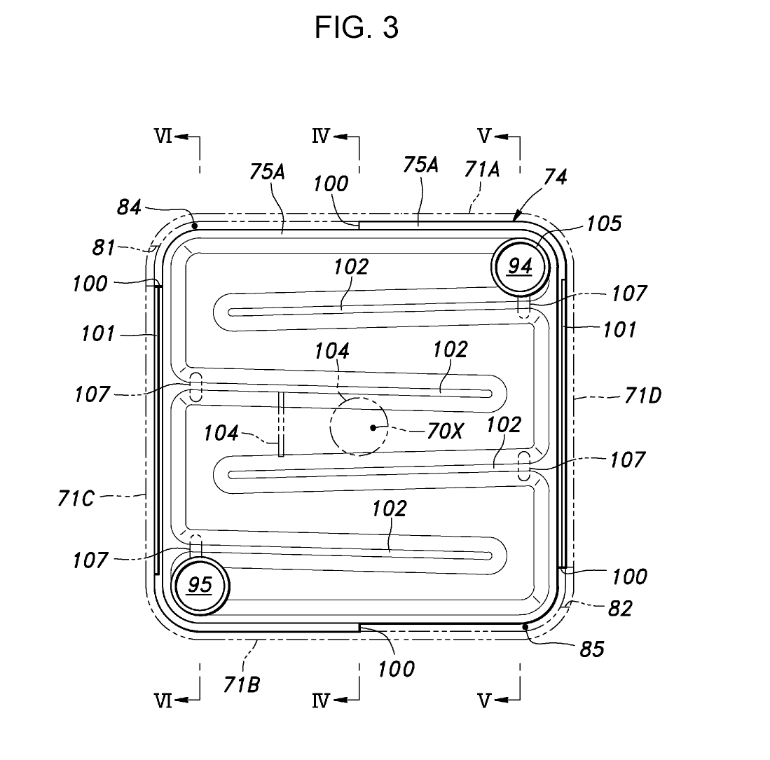

A plurality of heat transfer plate units 74 are stacked while being spaced apart from each other inside the housing 70 in the axis 70X direction (the front-back direction) of the housing 70. The heat transfer plate units 74 are each constituted by plurality of heat transfer plates 75 (75A and 75B) stacked in the axis 70X direction of the housing 70. The spaces between adjacent heat transfer plate units 74 form, working together with the housing 70, a first flow path 80 (accurately, first branched flow paths 83 described later) through which the raw fuel flows. Each of the heat transfer plate units 74 forms therein a second flow path 90 (accurately, second branched flow paths 93 described later, see FIG. 3) through which the high octane rating fuel flows. In other words, a plurality of heat transfer plate 75 that are stacked in the axis 70X direction of the housing 70 and that form, working together with the housing 70, the first flow path 80 and the second flow path 90 are provided inside the housing 70.

A first fluid inlet 81 into which the raw fuel flows is formed in the vicinity of the left upper corner portion 71E of the housing body 71. The first fluid inlet 81 is disposed in the vicinity of the front end that is a first end of the housing body 71 in the axis 70X direction. The first fluid inlet 81 is formed of a through hole formed in the left wall 71C of the housing body 71, and an inlet connection pipe 76 that is joined to the housing body 71 so as to be connected to the through hole and that extends parallel to the upper wall 71A in the left-right direction. The conduit 21 (FIG. 1) is connected to the inlet connection pipe 76. Furthermore, a first fluid outlet 82 out of which the raw fuel flows is formed in the vicinity of the lower left corner portion 71E that is positioned diagonal to where the corner portion 71E of the housing body 71 in which the first fluid inlet 81 is provided is positioned. The first fluid outlet 82 is disposed in the vicinity of the back end that is a second end of the housing body 71 in the axis 70X direction. The first fluid outlet 82 is formed of a through hole formed in the right wall 71D of the housing body 71, and an outlet connection pipe 77 that is joined to the housing body 71 so as to be connected to the through hole and that extends parallel to the lower wall 71B in the left-right direction. The conduit 21 (FIG. 1) is also connected to the outlet connection pipe 77.

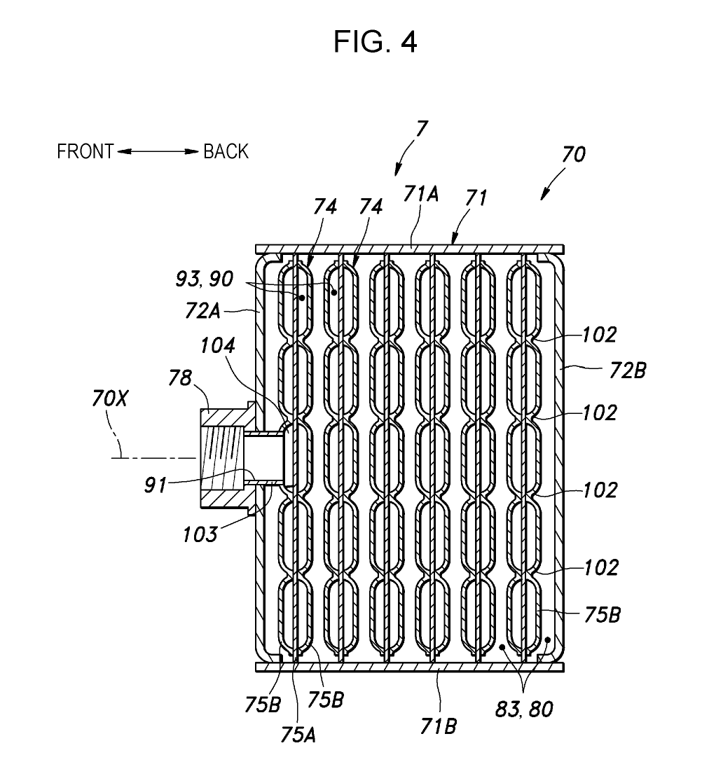

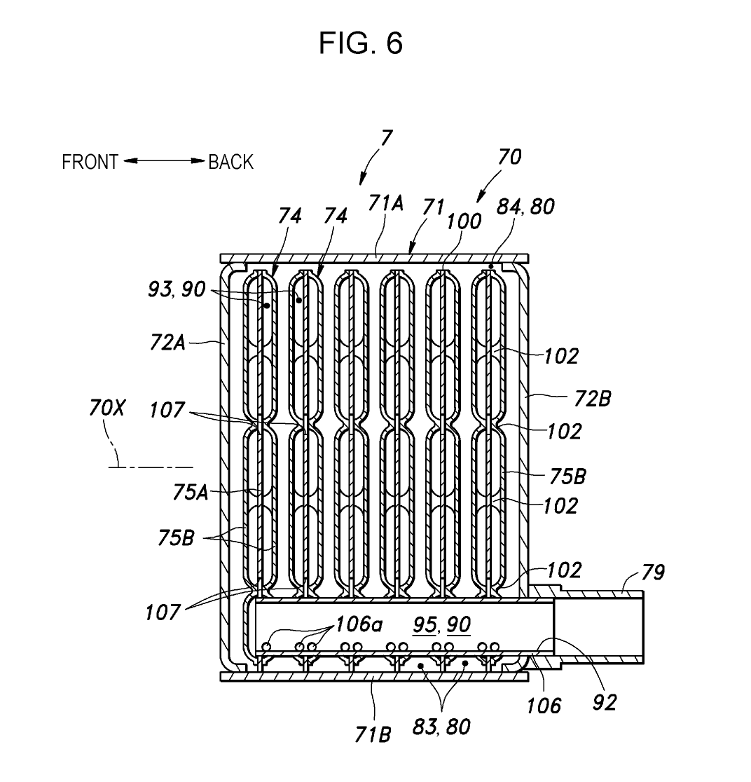

A second fluid inlet 91 into which the gaseous high octane rating fuel flows is formed in the middle portion of the front side lid member 72A. The second fluid inlet 91 is formed of a connection pipe 103 (FIG. 4) described later that is attached to the front side lid member 72A so as to penetrate therethrough, and an inlet nut 78 that is joined to the lid member 72A so as to be connected to the connection pipe 103 and that extends in the axis 70X direction of the housing 70. The conduit 22 (FIG. 1) is connected to the inlet nut 78. Furthermore, a second fluid outlet 92 out of which gaseous and liquid high octane rating fuel flows is formed in the lower left end of the back side lid member 72B. The second fluid outlet 92 is formed of a second connection pipe 106 (FIG. 6) described later that is attached to the back side lid member 72B so as to penetrate therethrough, and an outlet nut 79 (FIG. 6) that is joined to the lid member 72B so as to be connected to the second connection pipe 106 and that extends in the axis 70X direction of the housing 70. The conduit 22 (FIG. 1) is also connected to the outlet nut 79.

FIG. 3 is a front view of the heat transfer plate unit 74, and FIG. 4 is a cross-sectional view of the condenser 7 illustrating a position corresponding to line IV-IV in FIG. 3. As illustrated in FIGS. 3 and 4, each heat transfer plate unit 74 is formed in a substantially square shape in which the corner portions are curved. Each heat transfer plate unit 74 includes a base plate 75A formed of a flat steel plate in which a portion of the periphery is bent forward, and a flow path forming plate 75B that is formed in a substantially square dome shape (a protruded shape in which the middle portion is protruded with respect to the periphery formed as a flat surface). The entire periphery of each flow path forming plate 75B is joined to the corresponding base plate 75A such that the second branched flow path 93 serving as a branch portion of the second flow path 90 is formed between the base plate 75A.

In the present exemplary embodiment, the heat transfer plate unit 74 in which the second branched flow path 93 is formed on both surfaces of the base plate 75A is configured by a single base plate 75A and two flow path forming plates 75B joined to the two front and back surfaces of the base plate 75A. Six heat transfer plate units 74 are disposed inside the housing 70 with a gap between each other and with a gap with each lid member 72. Accordingly, as described later, seven first branched flow paths 83 forming branch portions of the first flow path 80 are formed inside the housing 70.

Each base plate 75A has a size and shape that corresponds to the inner contour (the inner surface) of the housing body 71, and is shaped so as to be formed with cutaways 100 at the upper left and the lower right portion thereof in the peripheral corner portions that correspond to the first fluid inlet 81 and the first fluid outlet 82 in the inner surface of the housing body 71. Meanwhile, each flow path forming plate 75B has an outer contour that is slightly smaller than the inner contour of the housing body 71 and has a shape corresponding to (substantially similar to) the shape of the inner contour. Each flow path forming plate 75B is connected to the corresponding base plate 75A in a coaxial manner. The outer edges of each base plate 75A where the cutaways 100 are formed have shapes that are the same as those of the outer edges of the flow path forming plate 75B.

The cutaways 100 of each base plate 75A is formed in an L-shape extending along the periphery of the flow path forming plate 75B, and a space having a predetermined width is formed with the inner surface of the housing body 71. In other words, the portions of the base plates 75A in which the upper left cutaways 100 have been formed serve as a first distribution portion 84 that distributes the raw fuel that has flowed in from the first fluid inlet 81 to the plurality of first branched flow paths 83. Furthermore, the portions of the base plates 75A in which the lower right cutaways 100 have been formed serve as a first gathering portion 85 that gathers the raw fuel that has flowed through the plurality of first branched flow paths 83 towards the first fluid outlet 82. The upper left and lower right cutaways 100 are each formed in an L-shape in which portions that extend in the horizontal direction (in other words, a portion that extends along the upper wall 71A or the lower wall 71B) are longer than the portions that extend in the vertical direction (in other words, a portion that extends along the left wall 71C or the right wall 71D).

As described above, the shapes of the portions of the base plates 75A in which the cutaways 100 are formed and the shapes of the outer edges of the path forming plates 75B are configured the same, and the L-shaped cutaways 100 are provided at two portions of each base plate 75A that are diagonal with respect to each other. Accordingly, when joining the flow path forming plates 75B to the base plate 75A, positioning can be performed easily by matching the outer edges of the heat transfer plates 75 at the portions where the cutaways 100 have been formed. A heat transfer plate unit 74 in which a plurality of heat transfer plates 75 have been integrated can be obtained by putting the plurality of heat transfer plates 75 to which positioning has been performed and that have been brought in contact with each other into an oven and brazing the plurality of heat transfer plates 75 together.

In the present exemplary embodiment, flanges 101 that protrude forward are formed in the straight portion in the left and right edges of each base plate 75A (portions other than where the cutaways 100 are formed). The flanges 101 are formed by bending a steel plate that forms the base plate 75A at an angle that is smaller than 90 degrees. In other words, the flanges 101 are inclined so as to be oriented more to the outside on the distal end side. Accordingly, in a state in which the base plates 75A are inserted in the housing body 71, the edges at the distal ends of the flanges 101 are in contact with the inner surface of the housing body 71 in an elastic manner. Accordingly, even if there were to be a machining error in the base plate 75A, the error can be absorbed by elastic deformation of the flanges 101. The heat transfer plate units 74 are integrated with the housing body 71 by being put in an oven and by being brazed after the heat transfer plate units 74 have been disposed at predetermined positions inside the housing body 71 and while in a state in which the edges of the distal ends of the flanges 101 are in contact with the inner surface of the housing body 71 in an elastic manner. Same applies for the lid members 72.

The flow path forming plate 75B joined to the front side of the base plate 75A and the flow path forming plate 75B joined to the back side of the base plate 75A are symmetrical to each other. Accordingly, herein, detailed description of the flow path forming plate 75B joined to the front side of the base plate 75A illustrated in FIG. 3 will be given.

As illustrated in FIGS. 3 and 4, each flow path forming plate 75B is formed with an uneven surface shape in which the entire periphery is recessed by press forming. Furthermore, a recessed wall, which is recessed during the press forming so as to be flush with the flat surface of the periphery, is formed in the middle portion of the flow path forming plate 75B. The recessed walls other than the periphery are flow path forming walls 102 that divide the first flow path 80. A flow path forming wall 102 that extends from the right edge portion in a substantially horizontal manner towards the left side and that is not long enough to reach the left edge portion, and a flow path forming wall 102 that extends from the left edge portion in a substantially horizontal manner towards the right side and that is not long enough to reach the right edge portion are provided alternately in the vertical direction. with the above, the second flow path 90 is formed to have a meander shape that zig-zags left and right. Each flow path forming walls 102 extending from the right edge portion towards the left side is inclined downwards towards the left side, and each flow path forming walls 102 extending from the left edge portion towards the right side is inclined downwards towards the right side. Note that it is only sufficient that the flow path forming walls 102 are narrowed and meandered and do not need to be joined to the base plate 75A throughout the entire length; accordingly, it is only sufficient that the low path forming walls 102 extend while approaching the base plate 75A from the periphery.

The connection pipe 103 is attached to the middle portion of the flow path forming plate 75B that is disposed at the very front in order to connect the inlet nut 78, serving as the second fluid inlet 91 by being joined to the front side lid member 72A (FIG. 2), and the second flow path 90 to each other. Furthermore, an obstacle 104 (illustrated in FIG. 3 by an imaginary line) that extends in the vertical direction and that blocks most of the second flow path 90 except for the lower end is provided on the left side (on the downstream side of the second branched flow path 93) of the connection pipe 103 in the flow path forming plate 75B disposed on the very front side. The obstacle 104 makes most of the gaseous high octane rating fuel that have flowed into the second flow path 90 from the connection pipe 103 to flow towards the upper side while permitting the liquid high octane rating fuel to flow downwards. The obstacle 104 may be constituted by the recessed wall formed by press forming, or may be another member that is additionally provided in the flow path forming plate 75B. The connection pipe 103 and the obstacle 104 are not provided in the other flow path forming plates 75B.

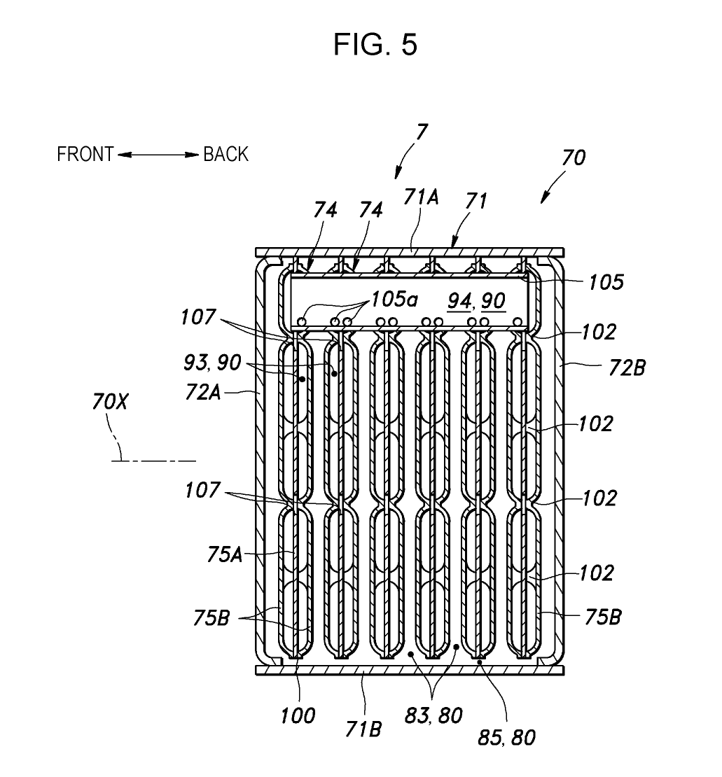

As illustrated in FIGS. 3 and 5, a first connection pipe 105 that connects the plurality of heat transfer plate units 74 stacked in the axis 70X direction is provided in the upper right portions of the heat transfer plate units 74. A front end of the first connection pipe 105 is open to, in the second flow path 90, the second branched flow path 93 that is at the very front. A back end of the first connection pipe 105 is open to, in the second flow path 90, the second branched flow path 93 that is at the very back. Furthermore, a plurality of outflow holes 105a are formed in the pipe wall of the first connection pipe 105 so as to open to, in the second flow path 90, the second branched flow paths 93 except for the one at the very front and the one at the very back. In other words, the upper side portion (the communication portion on the right side with respect to the obstacle 104 in FIG. 3) of the second branched flow path 93 at the very front and the internal space of the first connection pipe 105 serve as a second distribution portion 94 that distributes high octane rating fuel to the plurality of second branched flow paths 93.

As illustrated in FIGS. 3 and 6, a second connection pipe 106 that connects the plurality of heat transfer plate units 74 stacked in the axis 70X direction is provided in the lower left portions of the heat transfer plate units 74. A front end of the second connection pipe 106 is open to, in the second flow path 90, the second branched flow path 93 that is at the very front. The back end of the second connection pipe 106 penetrates through the back side lid member 72B and opens to the outside of the housing 70. The outlet nut 79 for connecting the conduit 22 (FIG. 1) is attached to the back end of the second connection pipe 106. Furthermore, a plurality of inflow holes 106a are formed in the pipe wall of the second connection pipe 106 so as to open to, in the second flow path 90, the second branched flow paths 93 except for the one at the very front. In other words, the internal space in the second connection pipe 106 serves as a second gathering portion 95 that gathers the high octane rating fuel flowing in the plurality of second branched flow paths 93.

As illustrated in FIGS. 3, 5, and 6, in the base plate 75A, communication holes 107 are formed at positions corresponding to the base ends of the flow path forming walls 102 so as to extend across the joint surfaces of the flow path forming walls 102 in the vertical direction. With the above, the upper and lower portions of the second flow path 90 that interpose the flow path forming walls 102 are in communication with each other through the communication holes 107. In the present exemplary embodiment, the communication holes 107 are formed so as to penetrate through the base plate 75A. In other exemplary embodiments, the communication holes 107 may be formed so as to recess the surface of the base plate 75A.

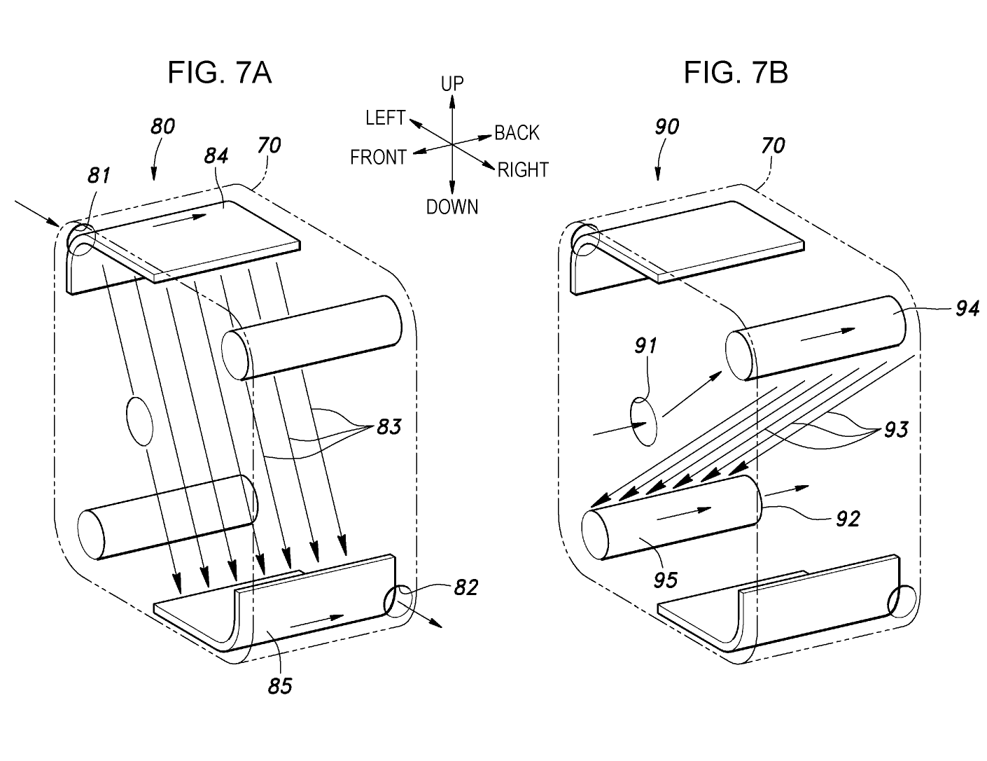

The effects of the condenser 7 configured in the above manner will be described below. FIG. 7A is a schematic diagram tangibly illustrating the first flow path 80 to illustrate the flow of the raw fuel, and FIG. 7B is a schematic diagram tangibly illustrating the second flow path 90 to illustrate the flow of the high octane rating fuel.

As illustrated in FIG. 7A, the raw fuel flows into the housing 70 from the first fluid inlet 81 and flows in the first distribution portion 84 towards the back while being distributed to the plurality of first branched flow paths 83. The raw fuel flowing through the first branched flow paths 83 flow from the upper left first distribution portion 84 to the lower right first gathering portion 85 along the surfaces of the heat transfer plate units 74 and is gathered to the first gathering portion 85. The raw fuel gathering to the first gathering portion 85 flows towards the back while gathering through the plurality of first branched flow paths 83, and is discharged to the outside through the first fluid outlet 82.

As described above, the first flow path 80 is formed between pairs of heat transfer plates 75 (75A and 75B) that are disposed adjacent to each other and includes the plurality of first branched flow paths 83 that are arranged in a parallel manner in the front-back direction, a first distribution portion 84 that extends in the front-back direction and that communicates the plurality of first branched flow paths 83 to each other, and a first gathering portion 85 that extends in the front-back direction and that communicates the plurality of first branched flow paths 83 to each other. Furthermore, the first distribution portion 84 is provided in the periphery of the heat transfer plates 75 in front view, the first fluid inlet 81 is in communication with the front side of the first distribution portion 84, the first gathering portion 85 is provided in the periphery of the heat transfer plates 75 in front view at a position that opposes the first distribution portion 84 with the center of the heat transfer plates 75 in between, and the first fluid outlet 82 is in communication with the back side of the first gathering portion 85.

With the above, in all of the flow paths that pass through the first branched flow paths 83 as well, since the lengths of the flow paths and the resistance in the flow paths from the first fluid inlet 81 to the first fluid outlet 82 are uniform, the amount of heat exchange in each first branched flow path 83 becomes uniform and the heat exchange rate of the condenser 7 becomes high.

As illustrated in FIG. 7B, the high octane rating fuel in a gaseous state flows into the housing 70 from the second fluid inlet 91. As illustrated together with FIGS. 3 and 4, the high octane rating fuel that has flowed into the housing 70 flows into the second distribution portion 94 after passing through the connection pipe 103 and the upper portion of the second branched flow path 93 at the very front. The liquid high octane rating fuel that has been cooled and condensed by the heat transfer plates 75 while passing through the upper portion of the second branched flow path 93 at the very front passes through the gap formed in the lower portion of the obstacle 104, flows to the lower portion of the second branched flow paths 93, and flows into the second gathering portion 95.

Meanwhile, the gaseous high octane rating fuel that has flowed into the second distribution portion 94 is, as illustrated in FIG. 7B, distributed to the plurality of second branched flow paths 93 formed between the pairs of heat transfer plates 75 (75A and 75B) adjacent to each other while flowing to the back side in the second distribution portion 94. The high octane rating fuel passing through each of the second branched flow paths 93 flows through the second branched flow paths 93 (FIG. 3) formed in a meander shape from the upper right second distribution portion 94 towards the lower left second gathering portion 95, and gathers to the second gathering portion 95. The high octane rating fuel that gathers from the plurality of second branched flow paths 93 to the second gathering portion 95 flows towards the back side and is discharged to the outside through the second fluid outlet 92.

The liquid high octane rating fuel that has been cooled and condensed by the heat transfer plates 75 while flowing through the second branched flow paths 93 flows, as illustrated in FIG. 3, downstream of the second branched flow paths 93 along the flow path forming walls 102 that are inclined downwards towards the distal end. Since the condenser 7 is used in the fuel separation device 1 that is mounted in an automobile, the orientation of the automobile and the acceleration in the front rear or in the left right may act on the high octane rating fuel as a force oriented towards the left or right in FIG. 3 disadvantageously causing the liquid high octane rating fuel to be accumulated in the left or the right. The liquid high octane rating fuel accumulated in the left or right in the above manner passes through the communication holes 107 and flows downstream of the flow path forming walls 102.

As described in FIGS. 3 to 6, and 7B, the second flow path 90 is formed between pairs of heat transfer plates 75 (75A and 75B) that are disposed adjacent to each other and includes the plurality of second branched flow paths 93 that are arranged in a parallel manner in the front-back direction, a second distribution portion 94 that extends in the front-back direction and that communicates the plurality of second branched flow paths 93 to each other, and a second gathering portion 95 that extends in the front-back direction and that communicates the plurality of second branched flow paths 93 to each other. Furthermore, the second distribution portion 94 is provided in the periphery of the heat transfer plates 75 in front view, the second fluid inlet 91 is in communication with the front side of the second distribution portion 94, the second gathering portion 95 is provided in the periphery of the heat transfer plates 75 in front view at a position that opposes the second distribution portion 94 with the center of the heat transfer plates 75 in between, and the second fluid outlet 92 is in communication with the back side of the second gathering portion 95.

With the above, in all of the flow paths that pass through the second branched flow paths 93 as well, since the lengths of the flow paths and the resistance in the flow paths from the second fluid inlet 91 to the second fluid outlet 92 are uniform, the amount of heat exchange in each second branched flow path 93 becomes uniform and the heat exchange rate of the condenser 7 becomes high.

As illustrated in FIG. 3, the heat transfer plates 75 are each substantially square, and in front view, the first distribution portion 84, the first gathering portion 85, the second distribution portion 94, and the second gathering portion 95 are disposed so as to be separated in the four corners of the heat transfer plate 75. Accordingly, the flow path length of the first branched flow paths 83 and the second branched flow paths 93 are both elongated and the heat exchange rate of the condenser 7 becomes high.

As illustrated in FIGS. 3 and 4, the second branched flow paths 93 are formed inside the plurality of heat transfer plate units 74 that are each configured by joining the peripheries of at least two heat transfer plates 75 to each other, the first flow path 80 is formed inside the cylindrical housing 70 accommodating the plurality of heat transfer plate units 74 having the axis 70X that coincide with the center of the heat transfer plates 75 and that are stacked in the front-back direction, the first branched flow paths 83 are formed between the pairs of adjacent transfer plate units 74, and the first distribution portion 84 and the first gathering portion 85 are formed by the cutaways 100 formed in the periphery of the heat transfer plate units 74. With the above, there will be no need to use a dedicated member to form the first gathering portion 85, and since the first gathering portion 85 is formed by the cutaways 100 provided in the peripheries of the heat transfer plate units 74, working man-hours and assembling man-hours can be reduced.

As illustrated in FIGS. 3, 5, and 6, the cross-sectional shape of the housing 70 and that of the heat transfer plate units 74 are substantially square, and the first distribution portion 84 and the first gathering portion 85 are formed in the corner portions of the heat transfer plate units 74. Accordingly, the cutaways 100 formed in the corner portions can be used to position at least two heat transfer plates 75 (75A and 75B) with respect to each other; accordingly, manufacturing of the heat transfer plate units 74 is facilitated.

As illustrated in FIGS. 2 and 3, the first fluid inlet 81 is formed in the left wall 71C that is among the pair of upper wall 71A and left wall 71C that interpose the corner portion where the first distribution portion 84 is formed in the housing 70. The first distribution portion 84 is formed by the L-shaped cutaways 100 in which the dimension extending along the upper wall 71A is larger than the dimension extending along the left wall 71C. With the above, since the shape of the first distribution portion 84 becomes large in the flow direction of the first fluid that flows in from the first fluid inlet 81, the first fluid can be suppressed from flowing, in a major manner, to the front side first branched flow paths 83 that are near the first fluid inlet 81 such that the amount of heat exchange in each first branched flow path 83 becomes uniform. Furthermore, since the cutaways 100 have an L-shape, positioning of at least two heat transfer plates 75 (74A and 75B) can be performed accurately by using the four sides in which the cutaways 100 have been formed.

As illustrated in FIGS. 3 and 4, the heat transfer plate units 74 each include a substantially tabular base plate 75A including the outer peripheral portion abutted against the housing 70, and a pair of flow path forming plates 75B that have a dome shape and that are joined to at least one side of the base plate 75A to form the second branched flow paths 93 with the base plate 75A. Accordingly, processing of the base plate 75A and the flow path forming plate 75B is facilitated and the second branched flow paths 93 can be formed easily.

As illustrated in FIGS. 2 and 3, the base plate 75A includes flanges 101 that are formed in the outer peripheral portion and that are in contact with the housing 70 in an elastic manner. With the above, even if there is a machining error in the base plate 75A, the error is absorbed by elastic deformation of the flanges 101; accordingly, manufacturing cost of the base plate 75A can be reduced and the base plate 75A can be installed in the housing 70 easily.

As illustrated in FIG. 2, the housing 70 is disposed in an orientation in which the axis 70X is substantially horizontal, raw fuel serving as a coolant flows through the first flow path 80, and high octane rating fuel that is condensed by heat exchange flows through the second flow path 90. Furthermore, as illustrated in FIG. 3, the second distribution portion 94 is disposed above the second branched flow paths 93, and the second gathering portion 95 is disposed below the second branched flow paths 93. Furthermore, as illustrated together with FIG. 4, the flow path forming plate 75B is recessed while approaching the base plate 75A from the periphery in a substantially horizontal direction, and includes a flow path forming walls 102 that meanders the second branched flow paths 93 from the second distribution portion 94 towards the second gathering portion 95. Accordingly, the condensed second fluid flows downwards with the gaseous flow and the gravitational force, and is easily gathered to the second gathering portion 95. Furthermore, since the flow path length of the second branched flow paths 93 becomes longer, the amount of heat exchange of a gaseous second fluid that has a low coefficient of heat transfer becomes larger. Furthermore, by forming the flow path forming plate 75B to have a recess, the flow path forming walls 102 are formed and the processing of the flow path forming walls 102 is facilitated.

As illustrated in FIG. 3, the upper surfaces of the flow path forming walls 102 are inclined downwards and downstream of the second flow path 90. Accordingly, with gravitational force, the condensed second fluid can be easily gathered to the second gathering portion 95.

As illustrated in FIG. 4, the flow path forming walls 102 are recessed walls formed in the flow path forming plate 75B, and the heat transfer plate units 74 include a pair of flow path forming plate 75B and 75B joined to both surfaces of the base plate 75A. Furthermore, as illustrated in FIGS. 3, 5, and 6, in the base plate 75A, the communication holes 107 that communicate the second branched flow paths 93 that are divided into upper and lower portions with the flow path forming walls 102 are formed at positions corresponding to the base ends of the flow path forming walls 102. With the above, since the condensed second fluid passes through the communication hole 107 and flows downstream of the flow path forming walls 102, the condensed second fluid can be prevented from accumulating in the second branched flow paths 93 while the flow path length of the second branched flow paths 93 is elongated.

While the specific description of the exemplary embodiments is completed, note that a variety of modifications can be implemented without limiting the present disclosure to the exemplary embodiments described above. For example, in the exemplary embodiment described above, the heat exchanger is used as an example of a condenser used in the fuel separation device 1; however, the heat exchanger may be used for other purposes, may be used as a heat exchanger to cool liquid, or may be used as a heat exchanger for heating gas and liquid. Furthermore, as long as the modification does not depart from the scope of the present disclosure, modifications of, for example, specific configurations, the dispositions, the numbers, the material, the angle, and the size of each member and parts may be appropriately made. As regards the components that have been illustrated in the exemplary embodiment described above, all of the components do not necessarily have to be a necessity and may be selected appropriately.

According to one aspect of the present disclosure, a heat exchanger includes a plurality of heat transfer plates stacked in a first direction (a front-back direction), and either one of a first flow path through which a first fluid (raw fuel) flows and a second flow path through which a second fluid (high octane rating fuel) flows formed between a pair of the heat transfer plates adjacently disposed with respect to each other, the first flow path including a plurality of first branched flow paths formed between the pair of heat transfer plates adjacently disposed with respect to each other, the plurality of first branched flow paths arranged in parallel in the first direction, a first distribution portion provided in a periphery of the heat transfer plates when viewed in the first direction, the first distribution portion extending in the first direction and communicating the plurality of first branched flow paths to each other, a first gathering portion provided, when viewed in the first direction, in the periphery of the heat transfer plate at a position opposing the first distribution portion while interposing a center of the heat transfer plates with the first distribution portion, the first gathering portion extending in the first direction and communicating the first branched flow paths to each other, a first fluid inlet in communication with a first end side (front side) of the first distribution portion in the first direction, and a first fluid outlet in communication with a second end side (back side) of the first gathering portion in the first direction.

According to such a configuration, in all of the flow paths that pass through the first branched flow paths as well, since the lengths of the flow paths and the resistance in the flow paths from the first fluid inlet to the first fluid outlet are uniform, the amount of heat exchange in each first branched flow path becomes uniform and the heat exchange rate of the heat exchanger becomes high.

Furthermore, in the above disclosure, the second flow path may include a plurality of second branched flow paths formed between the pair of heat transfer plates adjacently disposed with respect to each other, the plurality of second branched flow paths arranged in parallel in the first direction, a second distribution portion provided in the peripheries of the heat transfer plates when viewed in the first direction, the second distribution portion extending in the first direction and communicating the plurality of second branched flow paths to each other, a second gathering portion provided, when viewed in the first direction, in the peripheries of the heat transfer plates at a position opposing the second distribution portion while interposing a center of the heat transfer plates with the second distribution portion, the second gathering portion extending in the first direction and communicating the second branched flow paths to each other, a second fluid inlet in communication with a first end side (front side) of the second distribution portion in the first direction, and a second fluid outlet in communication with a second end side of the second gathering portion in the first direction.

According to such a configuration, in all of the flow paths that pass through the second branched flow paths as well, since the lengths of the flow paths and the resistance in the flow paths from the second fluid inlet to the second fluid outlet are uniform, the amount of heat exchange in each second branched flow path becomes uniform and the heat exchange rate of the heat exchanger becomes high.

Furthermore, in the disclosure described above, the heat transfer plate may be substantially square, when viewed in the first direction, the first distribution portion, the first gathering portion, the second distribution portion, and the second gathering portion may be disposed so as to be separated in four corners of the heat transfer plates.

According to such a configuration, the length of the flow path of the first branched flow path and the second branched flow path can be made longer, and the heat exchange rate of the heat exchanger becomes higher.

Furthermore, in the disclosure described above, the second branched flow paths may be formed inside a plurality of heat transfer plate units each configured by joining peripheries of at least two heat transfer plates to each other, the first flow path may be formed inside a cylindrical housing having an axis that coincides with the center of the heat transfer plates, the cylindrical housing accommodating the plurality of heat transfer plate units stacked in the first direction, the first branched flow paths may be formed between the pair of heat transfer plate units adjacent to each other, and the first distribution portion and the first gathering portion may be formed with cutaways formed in the peripheries of the heat transfer plate units.

With such a configuration, there will be no need to use a dedicated member to form the first gathering portion, and since the first gathering portion is formed by the cutaways provided in the peripheries of the heat transfer plate units, working man-hours and assembling man-hours can be reduced.

Furthermore, in the disclosure described above, a cross-sectional shape of the housing and the heat transfer plate units may be substantially square, and the first distribution portion and the first gathering portion may be formed in the corner portions of the heat transfer plate units.

With such a configuration, the cutaways formed in the corner portions can be used to position at least two heat transfer plates with respect to each other; accordingly, manufacturing of the heat transfer plate units is facilitated.

Furthermore, in the disclosure described above, the first fluid inlet may be formed in one of a pair of walls that interpose the corner portion in which the first distribution portion of the housing is formed, and the first distribution portion may be formed by the cutaways having an L-shape, a dimension of the L-shape extending along one of the pair of walls may be larger than a dimension of the L-shape extending along the other one of the pair of walls.

With the above, since the shape of the first distribution portion becomes large in the flow direction of the first fluid that flows in from the first fluid inlet, the first fluid can be suppressed from flowing, in a major manner, to the front side first branched flow paths that are near the first fluid inlet such that the amount of heat exchange in each first branched flow path becomes uniform. Furthermore, since the cutaways have an L-shape, positioning of at least two heat transfer plates can be performed accurately by using the four sides in which the cutaways have been formed.

Furthermore, in the disclosure described above, the heat transfer plate units may each include a substantially tabular base plate including an outer peripheral portion that abuts against the housing, and a flow path forming plate that has a dome shape and that is joined to at least one side of the base plate to form the second branched flow paths with the base plate.

With the above, processing of the base plate and the flow path forming plate is facilitated and the second branched flow paths can be formed easily.

Furthermore, in the disclosure described above, the base plate may include a flange formed in an outer peripheral portion thereof, the flange being in contact with the housing in an elastic manner.

With such a configuration, even if there is a machining error in the base plate, the error is absorbed by elastic deformation of the flange; accordingly, manufacturing cost of the base plate can be reduced and the base plate can be installed in the housing easily.

Furthermore, in the disclosure described above, the housing may be disposed in an orientation in which the axis is substantially horizontal, the first fluid (raw fuel) serving as a coolant may flow through the first flow path, and the second fluid (high octane rating fuel) condensed by heat exchange may flow through the second flow path, the second distribution portion may be disposed above the second branched flow paths, and the second gathering portion may be disposed below the second branched flow paths, and the flow path forming plate may be recessed so as to extend in a substantially horizontal direction while approaching the base plate from the periphery, the flow path forming plate may include flow path forming walls that meander the second branched flow paths from the second distribution portion to the second gathering portion.

With such a configuration, the condensed second fluid flows downwards with the gaseous flow and the gravitational force, and is easily gathered to the second gathering portion. Furthermore, since the flow path length of the second branched flow paths becomes longer, the amount of heat exchange of a gaseous second fluid that has a low coefficient of heat transfer becomes larger. Furthermore, by recessing the flow path forming plate, the flow path forming walls can be formed and the processing of the flow path forming walls is facilitated.

Furthermore, in the disclosure described above, upper surfaces of the flow path forming walls may be inclined downwards and downstream of the second flow path.

With such a configuration, with gravitational force, the condensed second fluid can be easily gathered to the second gathering portion.

Furthermore, in the disclosure described above, the flow path forming walls may be recessed walls formed in the flow path forming plate, the heat transfer plate units may each include a pair of the flow path forming plate joined to both surfaces of the corresponding base plate, and a communication hole that communicates a portion in the second flow path that has been separated into an upper side and a lower side with the flow path forming walls may be formed in the base plate in a position corresponding to a base end of the flow path forming walls.

With such a configuration, since the condensed second fluid passes through the communication hole and flows downstream of the flow path forming walls, the condensed second fluid can be prevented from accumulating in the second branched flow paths while the flow path length of the second branched flow paths is elongated.

The disclosure described above can provide a heat exchanger that is capable of increasing the heat exchange efficiency and reducing size.

Obviously, numerous modifications and variations of the present invention are possible in light of the above teachings. It is therefore to be understood that within the scope of the appended claims, the invention may be practiced otherwise than as specifically described herein.

What is claimed is:

1. A heat exchanger, comprising:
a plurality of heat transfer plates stacked in a first direction; and
either one of a first flow path through which a first fluid flows and a second flow path through which a second fluid flows formed between a pair of the heat transfer plates adjacently disposed with respect to each other;
the first flow path including
a plurality of first branched flow paths formed between the pair of heat transfer plates adjacently disposed with respect to each other, the plurality of first branched flow paths arranged in parallel in the first direction,
a first distribution portion provided in a periphery of the heat transfer plates when viewed in the first direction, the first distribution portion extending in the first direction and communicating the plurality of first branched flow paths to each other,
a first gathering portion provided, when viewed in the first direction, in the periphery of the heat transfer plate at a position opposing the first distribution portion while interposing a center of the heat transfer plates with the first distribution portion, the first gathering portion extending in the first direction and communicating the first branched flow paths to each other,
a first fluid inlet in communication with a first end side of the first distribution portion in the first direction, and
a first fluid outlet in communication with a second end side of the first gathering portion in the first direction.

2. The heat exchanger according to claim 1, wherein the second flow path includes
a plurality of second branched flow paths formed between the pair of heat transfer plates adjacently disposed with respect to each other, the plurality of second branched flow paths arranged in parallel in the first direction,
a second distribution portion provided in the peripheries of the heat transfer plates when viewed in the first direction, the second distribution portion extending in the first direction and communicating the plurality of second branched flow paths to each other,
a second gathering portion provided, when viewed in the first direction, in the peripheries of the heat transfer plates at a position opposing the second distribution portion while interposing a center of the heat transfer plates with the second distribution portion, the second gathering portion extending in the first direction and communicating the second branched flow paths to each other,
a second fluid inlet in communication with a first end side of the second distribution portion in the first direction, and
a second fluid outlet in communication with a second end side of the second gathering portion in the first direction.

3. The heat exchanger according to claim 2,
wherein the heat transfer plate is substantially square, and
wherein, when viewed in the first direction, the first distribution portion, the first gathering portion, the second distribution portion, and the second gathering portion are disposed so as to be separated in four corners of the heat transfer plates.

4. The heat exchanger according to claim 2,
wherein the second branched flow paths are formed inside a plurality of heat transfer plate units each configured by joining peripheries of at least two heat transfer plates to each other,
wherein the first flow path is formed inside a cylindrical housing having an axis that coincides with the center of the heat transfer plates, the cylindrical housing accommodating the plurality of heat transfer plate units stacked in the first direction,
wherein the first branched flow paths are formed between the pair of heat transfer plate units adjacent to each other, and
wherein the first distribution portion and the first gathering portion are formed with cutaways formed in the peripheries of the heat transfer plate units.

5. The heat exchanger according to claim 4,
wherein a cross-sectional shape of the housing and the heat transfer plate units are substantially square, and
wherein the first distribution portion and the first gathering portion are formed in the corner portions of the heat transfer plate units.

6. The heat exchanger according to claim 5,
wherein the first fluid inlet is formed in one of a pair of walls that interpose the corner portion in which the first distribution portion of the housing is formed, and
wherein the first distribution portion is formed by the cutaways having an L-shape, a dimension of the L-shape extending along one of the pair of walls being larger than a dimension of the L-shape extending along the other one of the pair of walls.

7. The heat exchanger according to claim 4, wherein the heat transfer plate units each include a substantially tabular base plate including an outer peripheral portion that abuts against the housing, and a flow path forming plate that has a dome shape and that is joined to at least one side of the base plate to form the second branched flow paths with the base plate.

8. The heat exchanger according to claim 7, wherein the base plate includes a flange formed in an outer peripheral portion thereof, the flange being in contact with the housing in an elastic manner.

9. The heat exchanger according to claim 7,
wherein the housing is disposed in an orientation in which the axis is substantially horizontal, the first fluid serving as a coolant flows through the first flow path, and the second fluid condensed by heat exchange flows through the second flow path,
wherein the second distribution portion is disposed above the second branched flow paths, and the second gathering portion is disposed below the second branched flow paths, and
wherein the flow path forming plate is recessed so as to extend in a substantially horizontal direction while approaching the base plate from the periphery, the flow path forming plate includes flow path forming walls that meander the second branched flow paths from the second distribution portion to the second gathering portion.

10. The heat exchanger according to claim 9, wherein upper surfaces of the flow path forming walls are inclined downwards and downstream of the second flow path.

11. The heat exchanger according to claim 10,
wherein the flow path forming walls are recessed walls formed in the flow path forming plate,
wherein the heat transfer plate units each include a pair of the flow path forming plate joined to both surfaces of the corresponding base plate, and
wherein a communication hole that communicates a portion in the second flow path that has been separated into an upper side and a lower side with the flow path forming walls is formed in the base plate in a position corresponding to a base end of the flow path forming walls.

12. A heat exchanger comprising:
a first flow path through which a first fluid flows;
a second flow path through which a second fluid flows; and
heat transfer plates stacked in a first direction, each of the heat transfer plates being provided between the first flow path and the second flow path in the first direction;
the first flow path comprising:
first branched flow paths provided between the heat transfer plates and arranged in parallel in the first direction;
a first distribution portion provided at a first position in a periphery of the heat transfer plates viewed in the first direction, the first distribution portion connecting the first branched flow paths, the first distribution portion extending in the first direction to have a first end and a second end opposite to the first end in the first direction;
a first gathering portion provided at a second position in the periphery of the heat transfer plates viewed in the first direction, the second position being opposite to the first position with respect to a center of the heat transfer plates viewed in the first direction, the first gathering portion connecting the first branched flow paths, the first gathering portion extending in the first direction to have a third end and a fourth end opposite to the third end in the first direction, the fourth end being opposite to the first end with respect to the heat transfer plates viewed in a second direction perpendicular to the first direction;
a first fluid inlet communicating with the first end of the first distribution portion in the first direction; and
a first fluid outlet communicating with the fourth end of the first gathering portion in the first direction.

13. The heat exchanger according to claim 12, wherein the second flow path includes
second branched flow paths provided between the heat transfer plates and arranged in parallel in the first direction,
a second distribution portion provided at a third position in a periphery of the heat transfer plates viewed in the first direction, the second distribution portion connecting the second branched flow paths, the second distribution portion extending in the first direction to have a fifth end and a sixth end opposite to the fifth end in the first direction,
a second gathering portion provided at a fourth position in the periphery of the heat transfer plates viewed in the first direction, the fourth position being opposite to the third position with respect to the center of the heat transfer plates viewed in the first direction, the second gathering portion connecting the second branched flow paths, the second gathering portion extending in the first direction to have a seventh end and an eighth end opposite to the seventh end in the first direction, the eighth end being opposite to the fifth end with respect to the heat transfer plates viewed in the second direction,
a second fluid inlet communicating with the fifth end of the second distribution portion in the first direction, and
a second fluid outlet communicating with the eighth end side of the second gathering portion in the first direction.

14. The heat exchanger according to claim 13,
wherein each of the heat transfer plates is substantially square, and
wherein the first distribution portion, the first gathering portion, the second distribution portion, and the second gathering portion are disposed so as to be separated in four corners of the heat transfer plates viewed in the first direction.

15. The heat exchanger according to claim 13,
wherein the second branched flow paths are provided inside heat transfer plate units each configured by joining peripheries of at least two of the heat transfer plates,
wherein the first flow path is provided inside a cylindrical housing having an axis that coincides with the center of the heat transfer plates, the cylindrical housing accommodating the heat transfer plate units stacked in the first direction,
wherein the first branched flow paths are provided between the heat transfer plate units, and
wherein the first distribution portion and the first gathering portion are provided in cutaways which is provided in the peripheries of the heat transfer plate units.

16. The heat exchanger according to claim 15,
wherein a cross-sectional shape of the housing and the heat transfer plate units are substantially square, and
wherein the first distribution portion and the first gathering portion are provided in the corner portions of the heat transfer plate units viewed in the first direction.

17. The heat exchanger according to claim 16,
wherein the first fluid inlet is formed in one of a pair of walls that interpose the corner portion in which the first distribution portion of the housing is formed, and
wherein the first distribution portion is provided in the cutaways having an L-shape, a dimension of the L-shape extending along one of the pair of walls being larger than a dimension of the L-shape extending along the other one of the pair of walls.

18. The heat exchanger according to claim 15, wherein each of the heat transfer plate units includes a substantially tabular base plate including an outer peripheral portion that abuts against the housing, and a flow path forming plate that has a dome shape and that is joined to at least one side of the base plate to form the second branched flow paths with the base plate.

19. The heat exchanger according to claim 18, wherein the base plate includes a flange provided in an outer peripheral portion thereof, the flange being in contact with the housing in an elastic manner.

20. The heat exchanger according to claim 18,
wherein the housing is disposed in an orientation in which the axis is substantially horizontal, the first fluid serving as a coolant flows through the first flow path, and the second fluid to be condensed by heat exchange flows through the second flow path,
wherein the second distribution portion is disposed above the second branched flow paths, and the second gathering portion is disposed below the second branched flow paths, and
wherein the flow path forming plate is recessed so as to extend in a substantially horizontal direction while approaching the base plate from the periphery, the flow path forming plate includes flow path forming walls that meander the second branched flow paths from the second distribution portion to the second gathering portion.

21. The heat exchanger according to claim 20, wherein upper surfaces of the flow path forming walls are inclined downwards and downstream of the second flow path.

22. The heat exchanger according to claim 21,
wherein the flow path forming walls are recessed walls provided in the flow path forming plate,
wherein each of the heat transfer plate units includes a pair of the flow path forming plate joined to both surfaces of the corresponding base plate, and
wherein a communication hole that communicates a portion in the second flow path that has been separated into an upper side and a lower side with the flow path forming walls is provided in the base plate in a position corresponding to a base end of the flow path forming walls.
